(19) United States
(12) Patent Application Publication
(10) Pub. No.: US 2010/0137755 A1
(43) Pub. Date: Jun. 3, 2010

(54) MASSAGE DEVICE

(76) Inventors: Masaki Nagano, Ibaraki-shi (JP); Takashi Yukawa, Hikone-shi (JP); Jyunji Nakamura, Hikone-shi (JP); Tetsushi Ogawa, Higashiosaka-shi (JP)

Correspondence Address: Cheng Law Group, PLLC, 1100 17th Street, N.W., Suite 503, Washington, DC, 20036, US

(21) Appl. No.: 12/596,132

(22) PCT Filed: Apr. 18, 2008
(86) PCT No.: PCT/JP2008/057630

§ 371 Date: Oct. 15, 2009

(30) Foreign Application Priority Data
Apr. 19, 2007 (JP) 2007-110917
Nov. 27, 2007 (JP) 2007-306599

(51) Int. Cl. A61H 1/00; A61H 15/00

(52) U.S. Cl. 601/15; 601/112

(57) ABSTRACT

The massaging device in this invention comprises a massaging mechanism, arms 3, and carriers 300. The carrier 300 has a shaft 30 which is fixed to the arm 3. The shaft 30 holds the massaging head 2 which is rotatable relative to the shaft 30. The carrier 300 carries the heat source 4 therein, and has a disc extending toward the radial direction of the shaft 30. The carrier 300 or the massaging head 20 includes a heat transfer means extending radially of the shaft from the carrier to an outer circumferential surface of the massaging head 20. This configuration makes it possible to transfer the heat to the outer circumferential surface of the carrier 300 or the massaging head.

### TECHNICAL FIELD

This invention relates to a massaging device which is configured to give massage to human's body by massage heads.

### BACKGROUND ART

Japanese patent application publication No. 2005-102919 discloses a conventional massage device. This massage device controls the massage heads to give the massage to the user's back. The massage head is, for example, arranged at a chair's backrest. The massage head is configured to apply the pressure to the user's back through a cover provided at a front of the backrest.

When a massager gives the massage to a man who receives the massage, hand's temperature of the massager is transferred to the man who receives the massage. Consequently, the massager gives satisfaction in addition to the massage to the man. However, the massage head of the massage device has a room temperature at the most. Concerning this, a heat source is assembled into the massage head. The massage head with the heat source is capable of giving warmth as well as pressure to the man. Therefore, the man is massaged by just like the hand, thereby being satisfied.

However, the massaging head is provided for applying the pressure to user's body. Therefore, the massaging head is made of elastic member such as rubber. This massaging head is formed into roller, thereby well moving with respect to a cover. The massaging head has an outer circumferential surface which comes into contact with the user's body through the cover. In this case, it is difficult to apply the heat to a circumferential part of the massaging head in order to apply the warmth to the user's body.

### DISCLOSURE OF THE INVENTION

This invention is achieved to solve the above problem. An object in this invention is to provide a massaging device which is configured to give effective massage while applying the warmth to the user's body.

To solve the above problem, the massaging device in this invention comprises a massaging mechanism, arms, a carrier, and a massaging head. The arms is held by the massaging mechanism. The carrier has a shaft which is fixed to the arm. The massaging head is rotatably supported to the carrier. The feature of the invention resides in that the massaging head is made of an elastic body. The carrier has a heat source. The carrier or the massaging head has a heat transfer means. The heat transfer means extends radially of the carrier to an outer circumferential surface of the massaging head. The heat transfer means is provided for transfer of heat generated by the heat source. The massaging device with this configuration makes it possible to give the massage to the user in addition to apply the warmth to the user by the heat transfer means.

It is preferred that the heat source is disposed at an inside of the shaft of the carrier. In this case, the heat source is configured to warm the carrier efficiently.

It is preferred that the carrier further comprises a disc which extends radially of the carrier. The disc defines the heat transfer means. The massaging head is arranged on opposite side of the disc. In this case, the disc is employed as the heat transfer means. Therefore, this configuration makes it possible to warm the outer circumferential surface of the massaging head by the heat source.

It is more preferred that the heat source is disposed at an inside of the disc. In this case, the heat source directly warms the disc which acts as the heat transfer means. Therefore, this configuration makes it possible to transfer the heat to the outer circumference surface of the massaging head efficiently. In addition, there is no need for harness to bend for connecting the heat source.

It is preferred that the massaging device further comprises a thrust washer. The thrust washer is interposed between the disc and the massaging head. In this case, the massaging head is smoothly slides relative to the disc. Consequently, the massaging head is configured to rotate about the shaft of the carrier smoothly.

It is preferred that the massaging device further comprising a bearing. The bearing is interposed between the massaging head and the carrier. The bearing and the thrust washer is made of heat insulating material. This configuration also makes it possible to keep the smooth rotation of the massaging head relative to the carrier. In addition, this configuration makes it possible to prevent the aging degradation.

It is preferred that the disc is formed with a hole. In this case, the disc has a heat capacity which is diminished by the hole. Therefore, the disc is easily warmed by the heat source. That is, this configuration makes it possible for the heat source to warm the disc efficiently.

It is preferred that the disc has an outer circumferential surface with a groove extending along a circumferential direction of the disc. This configuration makes it possible to effectively prevent the disc from applying pain to the user.

It is preferred that the outer circumferential surface of the disc is cooperative with an outer circumferential surface of the massaging head to form a continuous curved surface in a cross section along the shaft. This configuration makes it possible to enhance durability of the massaging head of a boundary portion with respect to the disc. In addition, it is more preferred that both sides of the massaging head have its outer circumferential surface having a curvature radius which is approximately equal to a curvature radius of the outer circumferential surface of the disc. In this case, it is possible to enhance the durability of the boundary portion of the massaging head with respect to the disc.

It is preferred that the carrier and the arm is made of electrically conductive material. In this case, it is possible to decrease insulation voltage required when the electrical current is supplied to the heat source. Therefore, it is possible to achieve downsizing and weight saving of the heat source. Furthermore, it is also possible to achieve the downsizing of the massaging head and the carrier.

It is preferred that the carrier is fixed to the arm so as not to rotate with respect to the arm. This configuration makes it possible to prevent the entanglement of electric wires connected to the heat source.

It is preferred that the heat transfer means is defined by a plurality of air holes. The air holes radially extend from center of a center of the massaging head to the outer circumferential surface of the massaging head. In this case, the heat is effectively transferred to the outer circumferential surface of the massaging head.

It is preferred that the massaging device further comprises a temperature sensor and a control means. The temperature sensor is configured to detect temperature of the heat source. The control means controls an electrical current which is supplied to the heat source on the basis of the temperature detected by the temperature sensor. In this case, the controls means controls the temperature of the heat source, thereby portion of the massaging head which comes into contact with the user's body being kept at a suitable temperature.

It is preferred that the massaging device further comprises a cooling means. The cooling means is configured to cool the massaging head. In this case, it is possible to cool the portion of the massaging head which comes into contact with the user's body is cooled effectively. Furthermore, it is also possible to effectively cool the heat source at the same time.

It is preferred that the massaging device further comprises a sub massaging head. The sub massaging head is located adjacent to the massaging head and has a heat source. In this case, the sub massaging head has its outer surface which is also configured to effectively have heat for applying the warm to the user's body.

### BRIEF DESCRIPTION OF THE DRAWINGS

FIG. 1 (a) is a perspective view of the massaging head, the carrier, and the arms of an embodiment in this invention.

FIG. 1 (b) is an exploded perspective view of the massaging head, the carrier, and the arms of the embodiment in this invention.

FIG. 2 (a) is a cross sectional view of the massaging head and the carrier of the embodiment in this invention.

FIG. 2 (b) is an exploded perspective view of the massaging head and the carrier of the embodiment in this invention.

FIG. 2 (c) is a partial cross sectional view of the massaging head and the carrier of the embodiment in this invention.

FIG. 3 is a perspective view of an entire massaging device in the embodiment of this invention.

FIG. 4 (a) is a perspective view of a first modification of the embodiment of this invention.

FIG. 4 (b) is a exploded perspective view of the first modification of the embodiment of this invention.

FIG. 5 is a schematic view of a second modification of the embodiment of this invention.

FIG. 6 is a schematic view of a third modification of the embodiment of this invention.

FIG. 7 is a timing chart of a temperature control of the above.

FIG. 8 is a perspective view of a fourth modification of the embodiment of this invention.

FIG. 9 (a) is an exploded perspective view of a fifth modification of the embodiment of this invention.

FIG. 9 (b) is a side cross sectional view of the fifth modification of the embodiment of this invention.

FIG. 10 is an exploded perspective view of a sixth modification of the embodiment of this invention.

FIG. 11 is a plane view for explanation of difference of direction of the harnesses in this embodiment.

FIG. 12 is an exploded perspective view of a seventh embodiment in this embodiment.

FIG. 13 is a side cross sectional view of the seventh embodiment in this embodiment.

FIG. 14 (a) is a side cross sectional view of an eighth modification of the embodiment in this invention.

FIG. 14 (b) is an expanded sectional view of the eighth modification of the embodiment in this invention.

FIG. 15 is an exploded perspective view of a ninth modification of the embodiment in this invention.

FIG. 16 is a side cross sectional view of a tenth modification of the embodiment in this invention.

FIG. 17 is a side cross sectional view of an eleventh modification of the embodiment in this invention.

FIG. 18 is an exploded perspective view of the above.

FIG. 19 (a) is an exploded perspective view showing an arrangement of the heat source within the disc in the above.

FIG. 19 (b) is a perspective view showing an arrangement of the heat source within disc in the above.

FIG. 20 is a side cross sectional view of a twelfth arrangement of the embodiment in this invention.

### BEST MODE FOR CARRYING OUT THE INVENTION

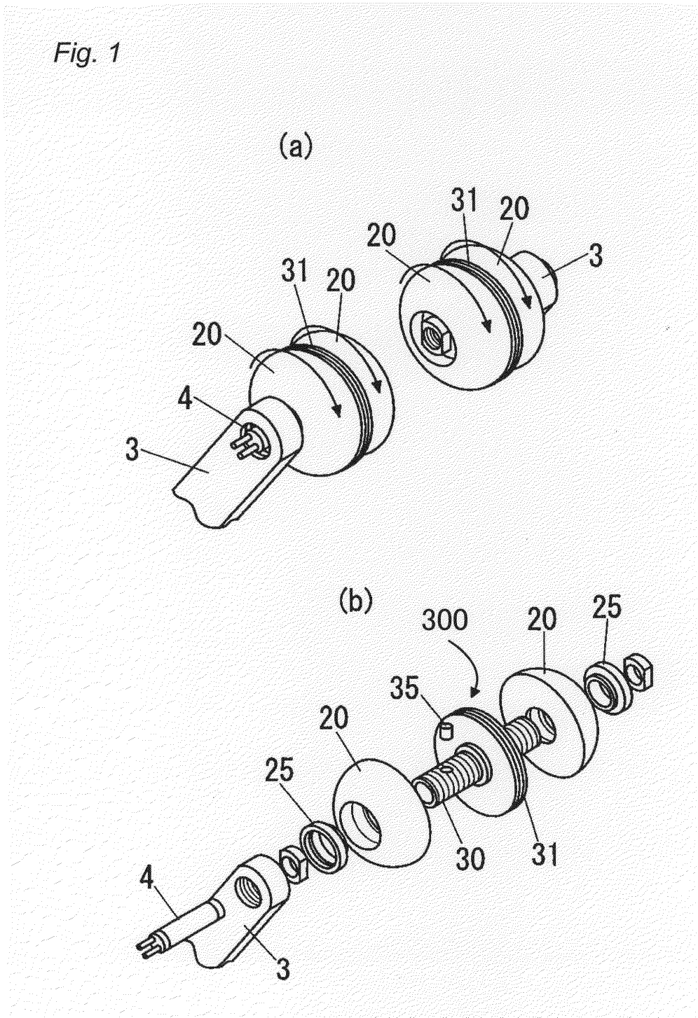

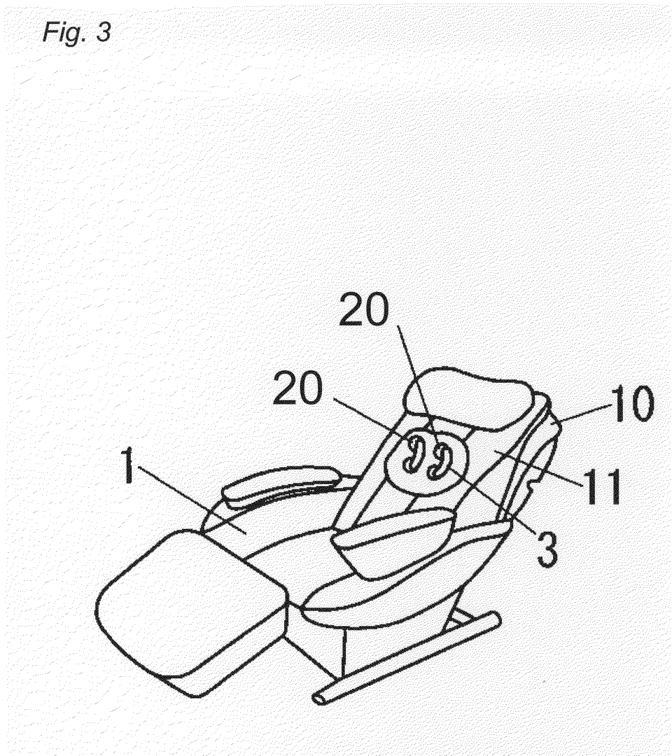

A massaging device in the embodiment of this invention is explained with attached drawings. FIG. 3 shows an external view of the massaging device in this embodiment. As shown in FIG. 1 to FIG. 3, the massaging device in this embodiment comprises a chair 1, a massaging mechanism which is not shown, arms 3, carriers 300, and massaging heads 20. The chair 1 has a backrest 10. The chair 1 is configured to recline. The massaging mechanism is configured to move upward and downward at an inside of the backrest 10. The arms 3 are coupled to the massaging mechanism. The carrier has a shaft 30 which is held by a tip of the arm 3. The massaging head 20 is rotatably supported to the shaft 30 of the carrier 30 through a bearing 25. The massaging head 20 is made of elastic body.

The shaft 30 of the carrier 300 has a hollow center. The shaft 30 is made of material such as aluminum, thereby the shaft 30 having high heat conductivity and stiffness. The carrier 300 is provided at its mid portion of an axial direction with a disc 31 for transferring the heat. The massaging heads 20 are arranged at right and left of the disc 31, respectively. The shaft 30 of the carrier 300 incorporates a heat source 4 defined by a sheathed heater. The heat source 4 is formed to have an outer diameter which is equal to an inner diameter of the shaft 30. The heat source 4 is disposed in the shaft 30 such that the outer surface of the heat source 4 comes into contact with an inside surface of the shaft 30. Therefore, the heat source 4 is disposed in the shaft 30 so that the heat of the heat source is surely transferred to the shaft 30. The heat source 4 is fixed to the shaft 30 by the screw 35.

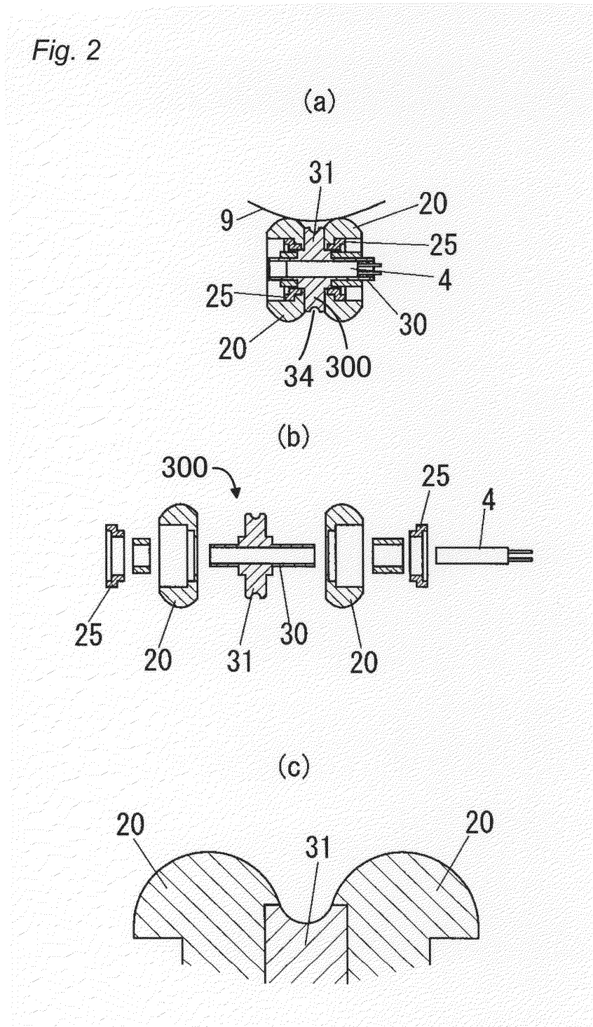

Referring to FIG. 2, the disc 31 is located between the massaging heads 20, and is formed to have an outer circumferential surface with a groove 34 which extends along a circumferential direction of the disc 31. The groove 34 of the disc 31 makes it possible to reduce the contact force applied to the user's body from the disc 31. Consequently, the groove 34 makes it possible to prevent the disc from applying pain to the user.

FIG. 2 (c) is a cross sectional view, along the shaft, of the massaging head 20 made of the elastic body, the carrier 300, and the disc 31. As shown in FIG. 2 (c), the disc 31 is formed at its circumferential surface with a groove extending along a circumferential direction of the disc 31. The groove 34 is cooperative with an outer circumferential surface of both sides of the discs to have a continuous curve in the cross sectional view. That is, the disc 31 has its outer circumferential surface cooperative with both of the massaging head 20 to form the continuous curved surface in the cross sectional view along an axial direction of the shaft. The massaging head comes has a contact portion which comes into contact with the disc. However, the above configuration enhances the durability of the contact portion.

The massaging device gives the massage to the body 9 by operating the massaging heads 20 while operating the heat source to generate the heat. At this time, the disc 31 of the carrier 300 is warmed by the heat that the heat source 4 generates. Therefore, the heat source 4 warms the outer circumferential surface of the disc 31 of the carrier 300 to a certain extent such that the outer circumferential surface of the disc 31, coming into contact with the user's body, applies the warmth to the user's body 9. In addition, as shown in the figures, the shaft 30 of the carrier 300 is fixed to the arm 3, and incorporates the heat source therein. Therefore, there is no entanglement of the electric wiring which is electrically connected to the heat source 4 even when the massaging head 20 is rotated.

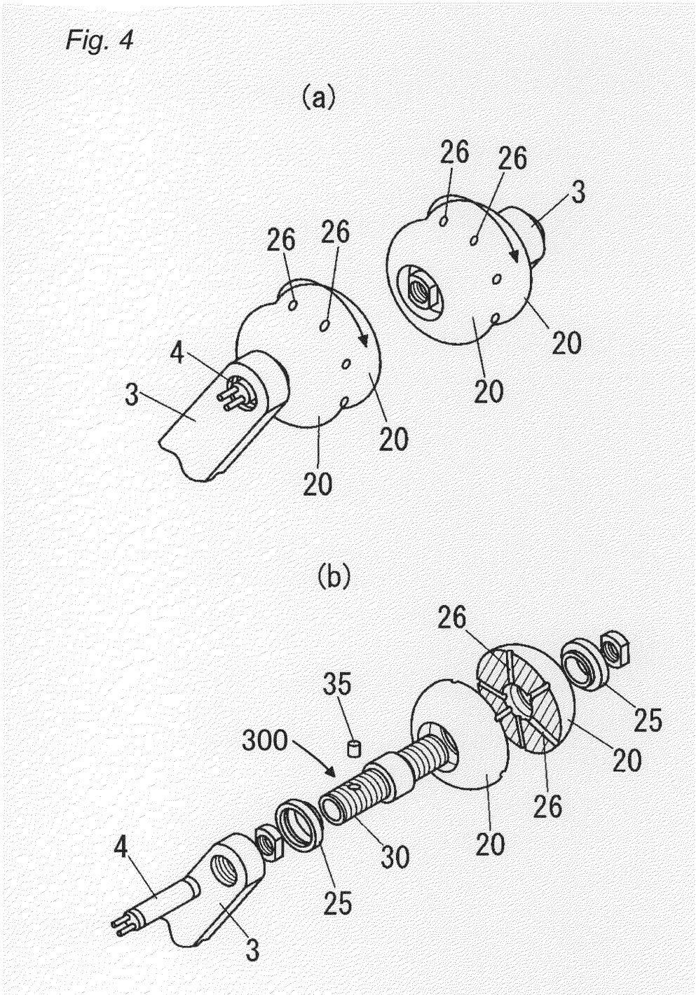

FIG. 4 is a first modification of the embodiment. The massaging head 20 has its outer circumferential surface. The outer circumferential surface has a mid portion in the width direction. The mid portion is grooved. The massaging head 20 is formed with a plurality of air holes extending from a radial center of the massaging head 20 and terminates at the mid portion of the groove. The heat generated at the heat source 4 is transferred to the outer circumferential surface of the massaging head 20 through the air holes 26. That is, the massaging head 20 is formed with a plurality of air holes 26 which act as a heat transfer means. In addition, it is preferred to fill highly heat-conductive material. In this case, the highly heat-conductive material transfers the heat to the outer circumferential surface of the massaging head 20.

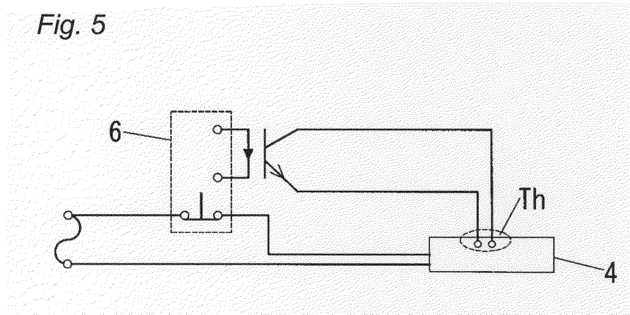

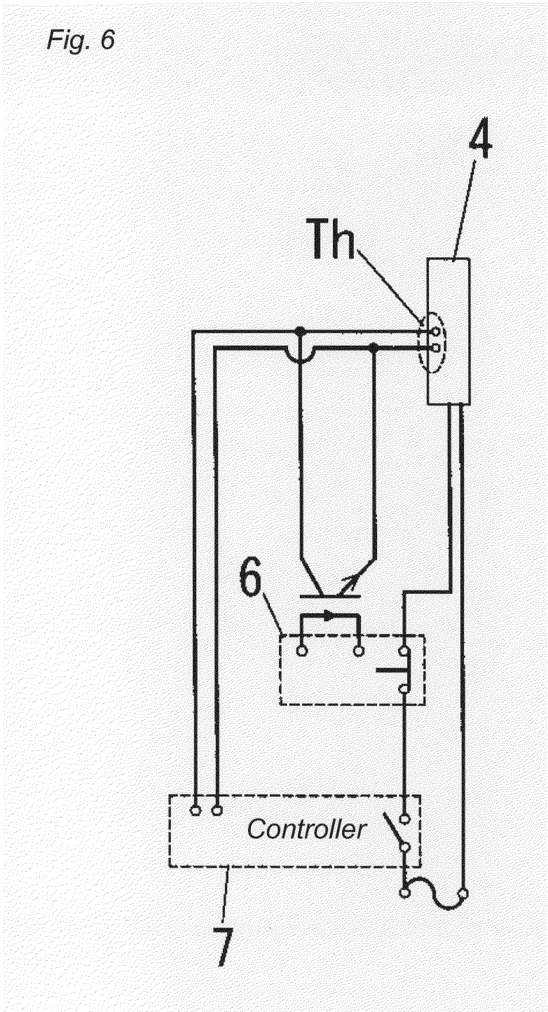

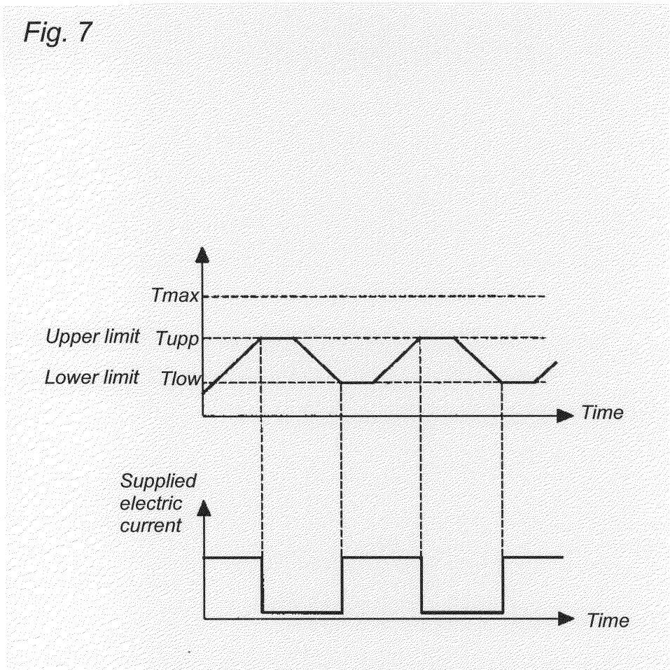

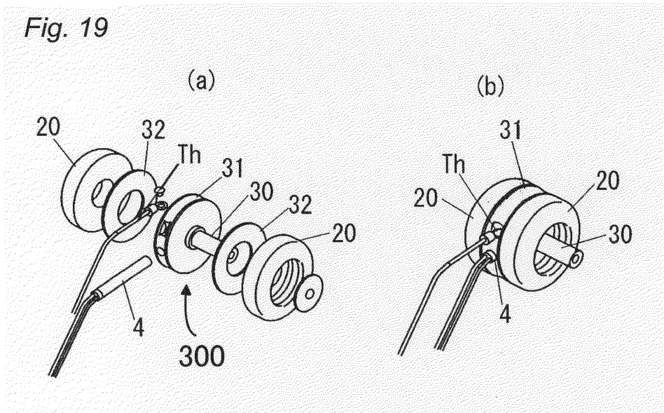

FIG. 5 is a second modification of the massaging device in this embodiment. As shown in FIG. 5, the massaging device comprises configurations of the above massaging device, and further comprises a temperature sensor Th and a circuit breaker 6. The circuit breaker 6 is defined by a relay contact which is electrically connected to the temperature sensor Th. The circuit breaker 6 is installed in series with the heat source 4. When the temperature sensor Th detects the temperature which exceeds a predetermined temperature Tmax, the circuit breaker is operated. Consequently, the circuit breaker 6 cuts the electricity supplied to the heat source 4. FIG. 6 is a third modification of the massaging device. As shown in FIG. 6, the massaging device further comprises a controller 7 in addition to the configurations in the second modification. The controller 7 controls the heat source 4 such that the temperature detected by the temperature sensor Th reaches a target temperature, shown in FIG. 7, which is lower than temperature of upper limit Tupp (Tupp<Tmax) and which is higher than the temperature of lower limit Tlow. In this manner, the controller 7 controls a surface of the disc 31 at a suitable temperature. Furthermore, it is preferred to incorporate the temperature sensor Th into the heat source 4. FIG. 19 shows the temperature sensor Th which is attached to an outer surface of the disc 31 of the carrier 300. In this case, it is possible to incorporate the temperature sensor Th into the carrier 300 easier than to incorporate the temperature sensor Th into the heat source 4. Therefore, it is possible to reduce cost for incorporating the temperature sensor Th into the carrier 300. Furthermore, in this case, the temperature sensor Th is attached to the disc 31. Therefore, the temperature sensor Th is capable of detecting the temperature which is same as temperature that the user actually feels. Therefore, this configuration makes it possible for the controller 7 to keep the surface of the disc 31 at a suitable temperature.

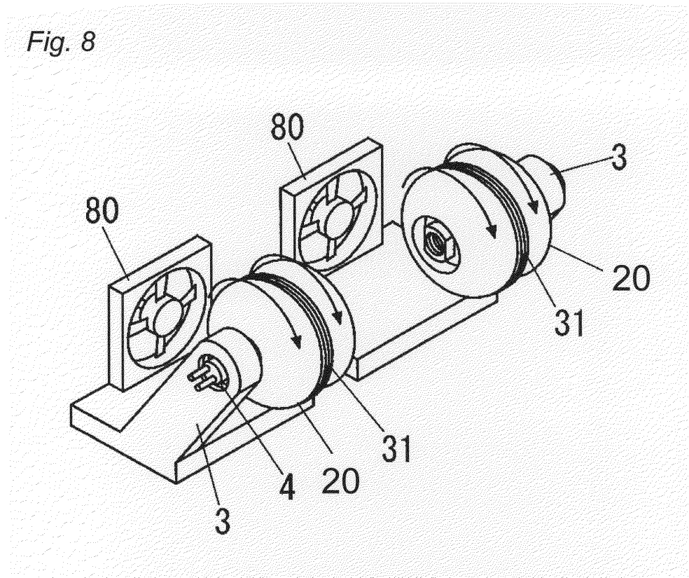

It is also preferred to employ the cooling means in addition to the heat source 4 for warming the disc 31 of the carrier 300 and the heat transfer means for transferring the heat to the outer circumferential surface of the massaging head 20. The cooling means is provided for cooling the massaging head 20. FIG. 8 shows the fourth modification of the embodiment. In this modification, the massaging device further comprises an air blower in addition to the configurations in the second modification. The air blower is disposed adjacent to the massaging head 20 and is configured to blow the air to the massaging head 20 and the carrier 300. The air blower 80 is mounted on the base formed on the arm 3. The air blower 80 mounted on the base of the arm 3 is started when the electricity which is supplied to the heat source 4 is cut. Consequently, the air blower 80 blows air to the massaging head 20 and the carrier 300, thereby cooling the massaging head 20 and the carrier 300 in a short time. So, this configuration makes it possible to keep the carrier 300 at a suitable temperature.

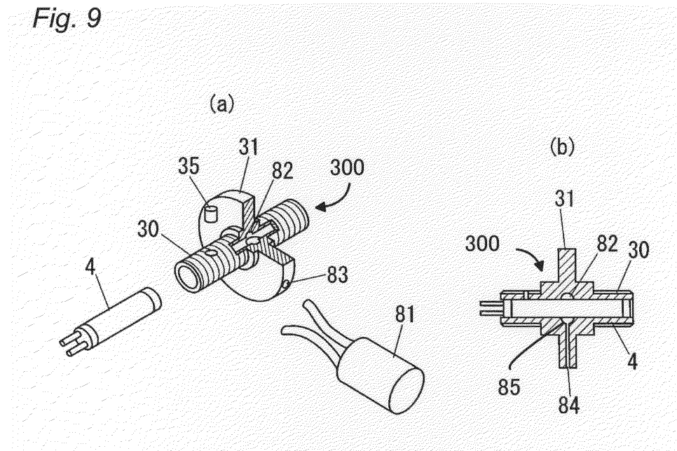

The pump which is configured to send cooling fluid to the shaft 30 is also employed as the cooling means. FIG. 9 shows the fifth modification of the embodiment. The massaging device in this modification comprises a pump 81 instead of the cooling means in the fourth modification. The pump 81 is configured to send the cooling liquid to the shaft 30. The carrier 300 is formed with a annular groove, a liquid inlet 83, and a liquid outlet 84. The shaft 30 is formed at its inside surface with the annular groove. The outer circumferential surface of the heat source 4 is cooperative with the annular groove 85 to form the cooling liquid channel 82. The disc 31 has its outer circumferential surface with the liquid inlet 83 and the liquid outlet 84 each of which is communicated with the cooling liquid channel 82. Consequently, this configuration cools the heat source 4 and the carrier 300 faster than the air blower 80 as mentioned above.

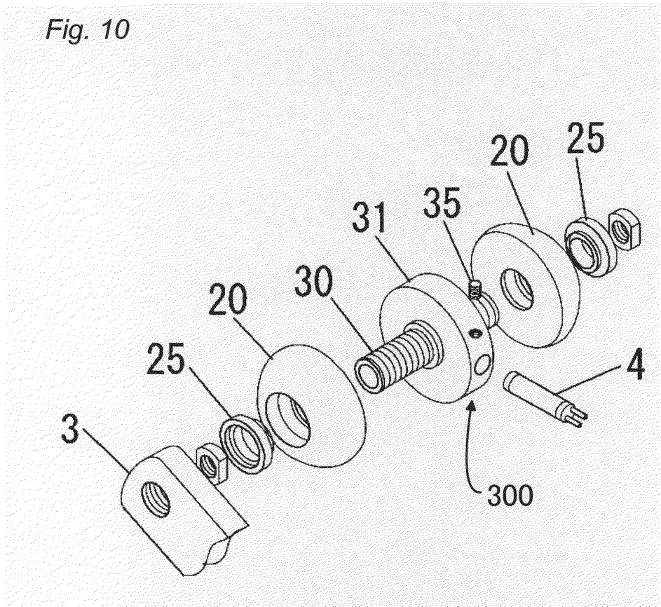

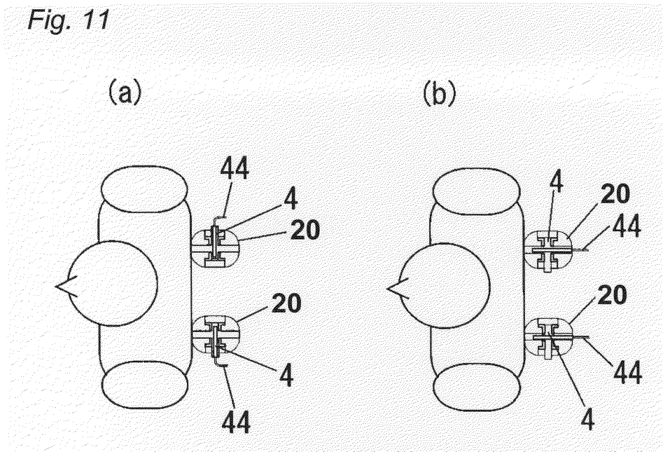

FIG. 10 shows the sixth modification of this embodiment. As shown in FIG. 10, the carrier 300 comprises the shaft 30 and the disc 31, wherein the heat source 4 is disposed at an inside of the disc 31. The rod-shaped heat source 4 is disposed in the disc 31 such that the rod-shaped heat source 4 has its axis which is perpendicular to the axis of the shaft 30 of the carrier 300. In a case where the heat source 4 is disposed at the inside of the shaft 30 of the carrier 300, the harness is electrically connected to the heat source 3 such that the harness 44 has a bent section in order to wire toward a rear side of the chair 1. On the other hand, in a case where the heat source is disposed at an inside of the disc 31 of the carrier 300, the harness is also electrically connected to the heat source 4 while the harness extends toward a rear side of the chair 1 straight. That is, in the case mentioned latter, there is no need to bend the harness. In addition, it is possible to prevent a contact of the harness 44 and a user's back when the user leans against the back of the chair 1. Therefore, this configuration makes it possible to prevent the brake of the harness at the bent section.

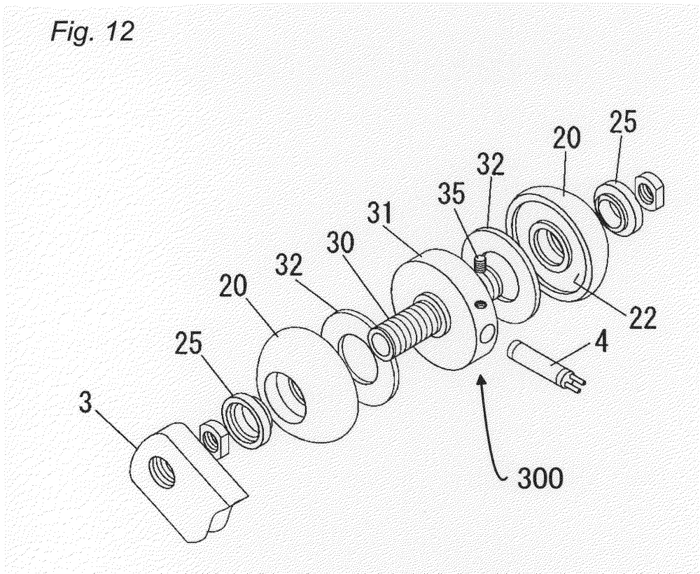

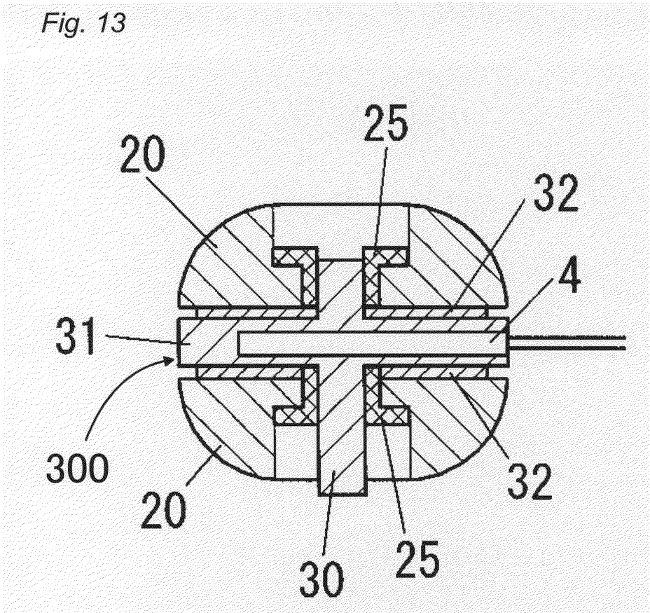

FIG. 12 and FIG. 13 show a seventh modification of the embodiment. FIG. 13 shows the disc 31 and the massaging heads 20 which are disposed along surfaces of the disc 31. The disc 31 is cooperative with the massaging heads 20 to hold thrust washers 32. Consequently, friction between the massaging head 20 and the disc 31 is reduced. Therefore, the massaging head 20 is free from the friction caused between the massaging head 20 and the disc 31. As a result, the massaging head 20 is smoothly rotated about the shaft 30. In addition, the massaging head 20 has one surface which is faced with the disc 31. The one surface of the massaging head 20 is formed with a recess 22. The recess 22 receives the thrust washer 32, thereby the thrust washer being held between the disc 31 and the massaging head 20. Therefore, with this configuration, the massaging heads 20 are free from the friction between the disc 31 and the massaging head 20. Consequently, the massaging heads 20 are smoothly rotated about the shaft 30.

In addition, it is preferred that the thrust washer 32 and the bearing 25 is made of material having heat insulation property. In this case, the thrust washer 32 and the bearing 25 prevent the heat of the carrier 300 from transmitting to the massaging heads 20. The massaging head 20 is made of the elastic body such as rubber and elastomer. However, the thrust washer 32 and the bearing 25 prevent the sulfurization and aging degradation of the massaging head 20 by the heat.

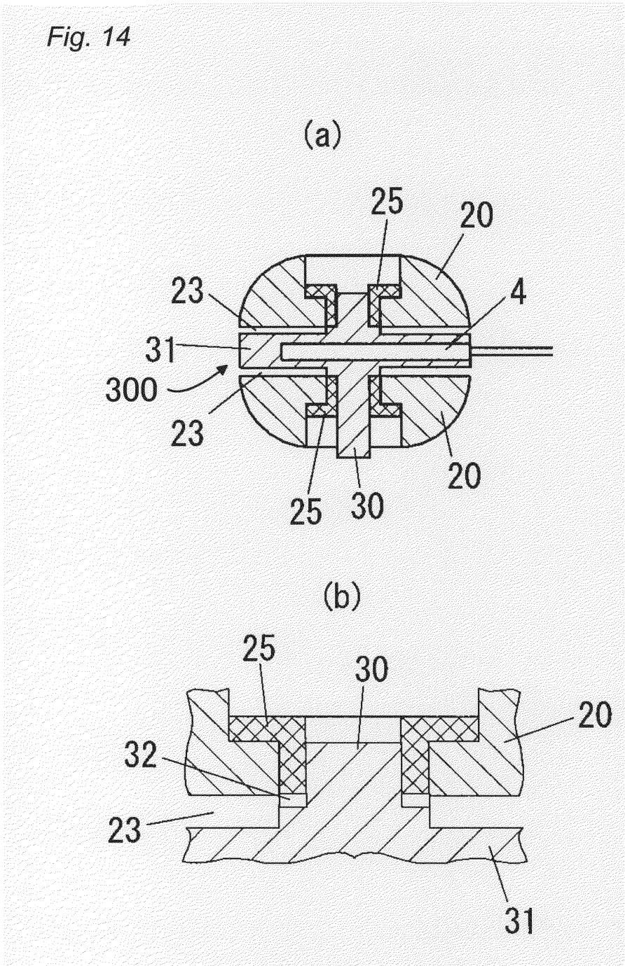

FIG. 14 shows the eighth modification of the embodiment. It is desired to prevent the heat transmission to the massaging head 20 made of the elastic body. Therefore, as shown in FIG. 14, it is preferred that the massaging head 20 is spaced from the disc 31 by a predetermined distance. Consequently, there is a narrow gap 23 between the surface of the disc 31 and the surface of the massaging head 20. Air present in the gap 23. Therefore, the air prevent the heat from transmitting to the massaging head 20 from the disc 31. In this case, it is preferred to dispose the thrust washer 32 such that the thrust washer 32 is only interposed between the shaft 30 of the carrier 300 and the bearing 25.

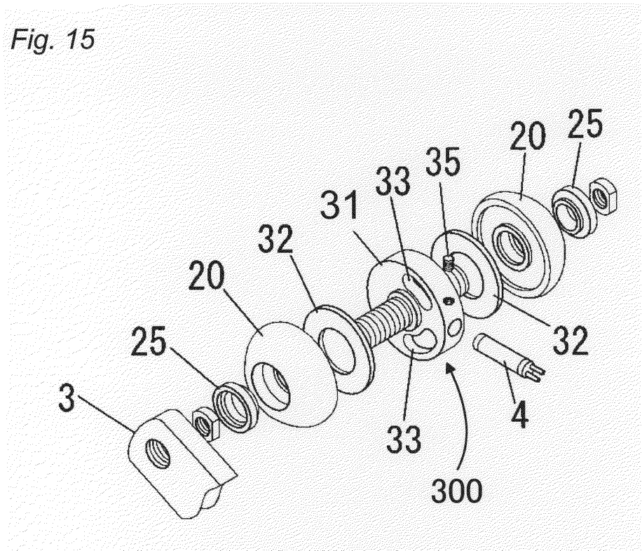

FIG. 15 is a ninth modification of the embodiment. As shown in FIG. 15, the disc 31 is formed with holes 33. Therefore, rate of heat transfer to the outer circumferential surface of the disc 31 is enhanced. In this case, it is more preferred to employ the disc 31 which is formed at its portion opposite to the user's side with the holes 33. Consequently, it is possible to warm the outer circumferential surface of the disc to a target temperature in a short time. In addition, it is possible to reduce weight of the disc 31 and is also possible to reduce the electricity required for the heat source 4.

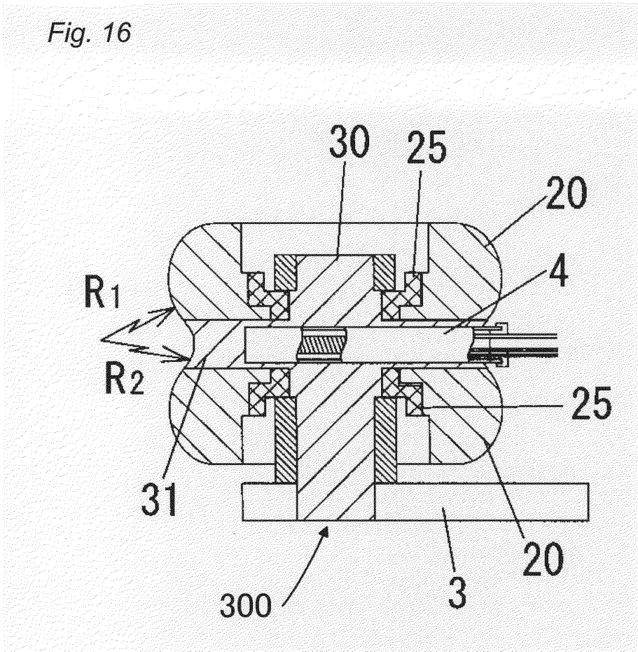

FIG. 16 is a tenth modification of the embodiment. The heat source 4 in this modification is also disposed at the inside of the disc 31. Furthermore, as shown in FIG. 16, the disc 31 is formed at its outer circumferential surface with the groove which extends along the circumferential direction of the disc 31. The outer circumferential surface of the disc is cooperative with the outer circumferential surface of the massaging head 20 to form a continuous curved surface. In addition, it is preferred that the outer circumferential surface of the massaging head 20 has a curvature radius R1 which is approximately equal to a curvature radius R2 of the outer circumferential surface, defined by the groove, of the disc 31. Consequently, pressure that the massaging head 20 receives from the user's body is spread evenly. Therefore, this configuration prevents the degradation of the contact portion between the disc 31 and the massaging head 20.

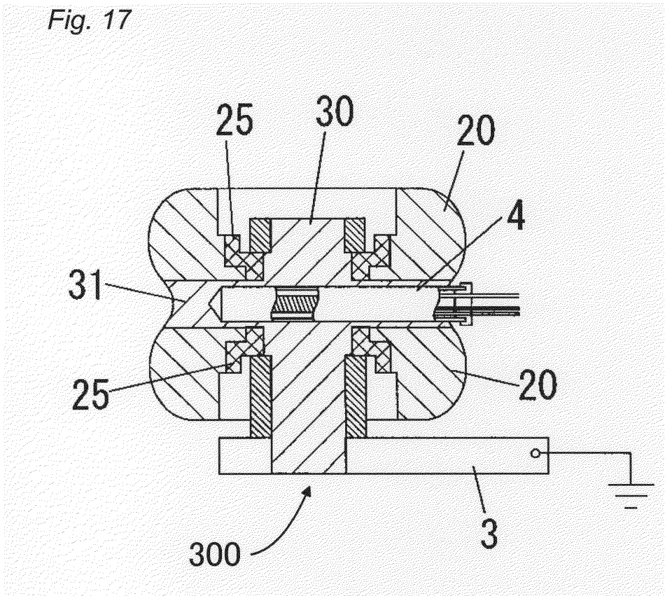

FIG. 17 shows the eleventh modification of the embodiment. Both the shaft 30 and the arm 3 are made of electrically conductive material. In addition, as shown in FIG. 17, the arm 3 is electrically grounded. Consequently, it is possible to reduce the insulation voltage required when the electrical current is supplied to the heat source 4. According to the above, downsizing and saving weight of the heat source is achieved. As a result, the downsizing and the saving weight of the massaging head 20 and the carrier 300 are achieved.

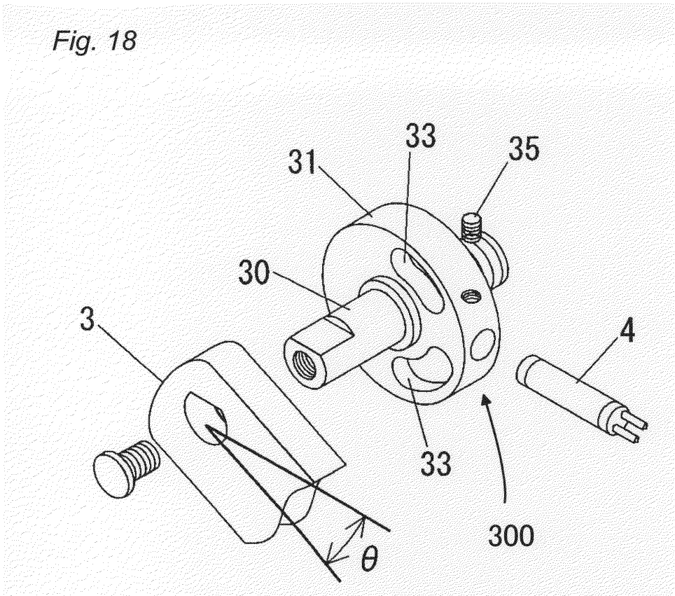

In the above embodiment, the shaft 30 of the carrier 300 is threadably mounted on the arm 3. However, it is also possible to fix the shaft 30 of the carrier 300 to the arm by a securing portion such that the carrier 300 is fixed to the arm 3. As shown in FIG. 18, the shaft 30 has one D-shaped end. The arm 3 has one end formed with a D-shaped hole. The carrier 300 is attached to the arm 3 such that the one D-shaped end of the shaft 30 is inserted into the D-shaped hole of the arm 3. Consequently, the carrier 300 is fixed to the arm 3 so as not to be rotated with respect to the arm 3. In the case where the shaft 30 of the carrier 300 is fixed to the arm 3, the disc 31 has its opening for passing the wiring electrically connected to the heat source 4 is oriented toward a direction opposite to the user's body. In addition, the disc 31 has its holes 33 being located at a rear side opposite to the user's body. Consequently, as shown in FIG. 18, the opening and the holes 33 is located within a range of θ opposite to the user's body. It is noted that the carrier 300 is capable of being fixed to the arm 3 by a key.

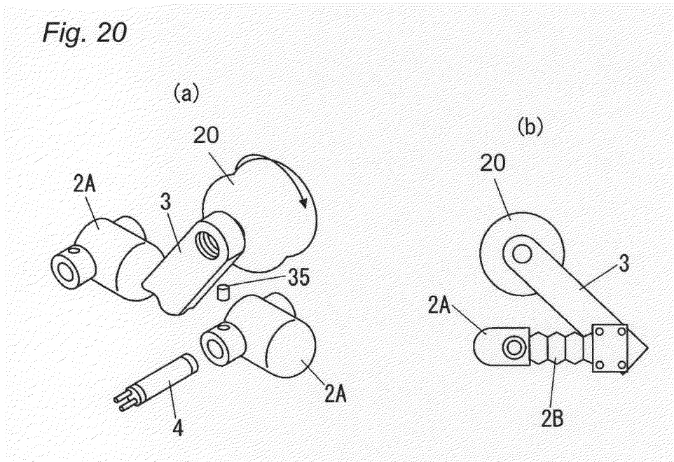

FIG. 20 shows the twelfth modification of the embodiment. The massaging device in this modification further comprises a sub massaging head 2A which is disposed adjacent to the massaging head 20. The sub massaging head 2a has a heat source. The sub massaging head 2A is made of a metal, thereby having a high heat conductive property. The sub massaging head 2a has its tip with semi-sphere shape. The sub massaging head 2A is moved toward a front and a rear by a linear actuator 2B arranged on the base of the arm 3. When the massaging device massages the user by the massaging head 20 moved by the massaging mechanism through the arm 3, the sub massaging head 2A is previously moved forwardly by the actuator 2B. Consequently, the sub massaging head 2A is capable of applying the warmth to the body. In this case, the sub massaging head 2A is kept from coming into strong contact with the user's body even when the sub massaging head 2A is located in a front position. Considering the above, it is preferred to employ the pneumatic actuator as the actuator 2B. In addition, if the user feels itching sensation by heat stimulation, the sub massaging head 2A is moved toward the rear direction such that only the massaging head 20 comes into contact with the user. It is noted that the circuit breaker 6 and the controller 7 are also adapted for the sub massaging head 2B.

Furthermore, the above embodiment and the modifications are explained on the basis of the chair 1 having the backrest 10 and the massaging heads 20 arranged on the backrest 10. However, the invention should not be limited to the above embodiment and the modifications. In addition, the present invention should be interpreted to encompass any combinations of the individual features of the embodiments.

1. A massaging device comprising:
a massaging mechanism;
arms being held by said massaging mechanism;
a carrier having a shaft which is fixed to said arm;
a massaging head rotatably supported to said carrier,
wherein
said massaging head is made of an elastic body,
said carrier has a heat source, and
said carrier or said massaging head having a heat transfer means which extends radially of said carrier to an outer circumference surface of said massaging head for transfer of heat generated by the heat source.

2. The massaging device of claim 1, wherein
said heat source is disposed at an inside of said shaft of said carrier.

3. The massaging device of claim 1, wherein
said carrier further comprises a disc extending radially of said carrier,
said disc defining said heat transfer means, and
said massaging head being arranged on opposite side of said disc.

4. The massaging device of claim 3, wherein
said heat source is disposed at an inside of said disc.

5. The massaging device of claim 3 further comprising a thrust washer being interposed between said disc and said massaging head.

6. The massaging device of claim 5, further comprising a bearing interposed between said massaging head and said carrier, and
said bearing and said thrust washer being made of heat insulating material.

7. The massaging device of claim 3, wherein
said disc is formed to have a hole.

8. The massaging device of claim 3, wherein
said disc has an outer circumferential surface with a groove extending along a circumferential direction of said disc.

9. The massaging device of claim 8, wherein
said outer circumferential surface of said disc is cooperative with an outer circumferential surface of said massaging head to form a continuous curved surface in a cross section along said shaft.

10. The massaging device of claim 9, wherein
said massaging head has its outer circumference surface having a curvature radius,
said outer circumferential surface of said disc has a curvature radius, and
the curvature radius of the outer circumferential surface of the disc is approximately equal to the curvature radius of the outer circumferential surface of the disc.

11. The massaging device of claim 1, wherein
each said carrier and said arm is made of electrically conductive material, and
said arm being electrically grounded.

12. The massaging device of claim 1, wherein
said carrier is fixed to said arm so as not to rotate with respect to said arm.

13. The massaging device of claim 1, wherein
said heat transfer means is defined by a plurality of air holes radially extending from center of said massaging head to said outer circumferential surface of said massaging head.

14. The massaging device of claim 1, further comprises a temperature sensor and a control means,
said temperature sensor being configured to detect temperature of said heat source, and
said control means controls an electrical current which is supplied to said heat source.

15. The massaging device of claim 1 further comprises a cooling means being configured to cool said massaging head.

16. The massaging device of claim 1 further comprises a sub massaging head which is located adjacent to said massaging head and which has a heat source.

17. The massaging device of claim 2, wherein
said carrier further comprises a disc extending radially of said carrier,
said disc defining said heat transfer means, and
said massaging head being arranged on opposite side of said disc.

18. The massaging device of claim 17, wherein
said heat source is disposed at an inside of said disc.

19. The massaging device of claim 17 further comprising a thrust washer being interposed between said disc and said massaging head.

20. The massaging device of claim 19, further comprising a bearing interposed between said massaging head and said carrier, and
said bearing and said thrust washer being made of heat insulating material.

21. The massaging device of claim 17, wherein
said disc is formed to have a hole.

22. The massaging device of claim 17, wherein
said disc has an outer circumferential surface with a groove extending along a circumferential direction of said disc.

23. The massaging device of claim 22, wherein
said outer circumferential surface of said disc is cooperative with an outer circumferential surface of said massaging head to form a continuous curved surface in a cross section along said shaft.

24. The massaging device of claim 23, wherein
said massaging head has its outer circumference surface having a curvature radius,
said outer circumferential surface of said disc has a curvature radius, and
the curvature radius of the outer circumferential surface of the disc is approximately equal to the curvature radius of the outer circumferential surface of the disc.
